(19) United States
(12) Patent Application Publication
(10) Pub. No.: US 2007/0015806 A1
(43) Pub. Date: Jan. 18, 2007

(54) NOVEL FORMULATION

(75) Inventors: David C. ROSS, Greensboro, NC (US); Keith PARKER, Greensboro, NC (US)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 11/457,877

(22) Filed: Jul. 17, 2006

Related U.S. Application Data
(60) Provisional application No. 60/700,078, filed on Jul. 18, 2005.

(51) Int. Cl. A01N 43/64; A01N 37/18

(52) U.S. Cl. 514/383; 514/621

(57) ABSTRACT

The present invention provides a liquid formulation comprising a strobilurin fungicide, such as azoxystrobin, at least one non-ionic surfactant, at least one anionic surfactant and a solvent/carrier.

The present invention relates to a formulation and in particular a liquid formulation of a strobilurin fungicide such as azoxystrobin for use on, inter alia, turf grass.

It is well known that active ingredients such as agrochemicals may be formulated along with adjuvants etc. that improve the efficacy of the active ingredient. Azoxystrobin, a strobilurin, is a fungicidal compound with a broad spectrum of disease control. Water-dispersible granular formulations of azoxystrobin offering superior dispersal properties are currently known for use on turf grass. These formulations allow absorption through every part of the turf plant, including the blade, stem and roots providing long lasting broad spectrum, systemic, disease control for up to 28 days against more than 33 disease organisms on turfgrass.

However, new formulations with improved properties are always of interest.

Accordingly, the present invention provides a new liquid formulation comprising (i) a strobilurin fungicide, such as azoxystrobin, (ii) at least one non-ionic surfactant, (iii) at least one anionic surfactant and (iv) a solvent/carrier.

This new formulation, which contains micro-grind particles in a unique micro-emulsifiable concentrate (MEC) formulation, has improved performance over known formulations. In particular, it has enhanced (e.g. faster and higher) foliar and root uptake and translocation coupled with a less rainfast leaf surface residue which allows for further increased uptake from the roots and subsequently greater delivery back into the leaves. The formulation consistently provides greater efficacy and better control for certain diseases such as Anthracnose, in particular strobilurin tolerant Anthracnose, than commercially-available formulations. In addition, it provides control of Dollar Spot, a disease not controlled by previous formulations of azoxystrobin.

In a particular embodiment, the formulation of the present invention comprises a non-ionic surfactant, a copolymer of propylene oxide (PO) and ethylene oxide (EO) and/or an ethoxylated tristyrene phenol. A suitable copolymer of PO and EO is α-butyl-ω-hydroxypoly (oxypropylene) block polymer with poly (oxyethylene) and has a molecular weight of 2,400 to 3,500. Commercially available examples of this copolymer are Toximul®, Witconol® and Atlas®. In a particular embodiment of the present invention, the copolymer is present at between about 1 and about 5 weight % and preferably at about 3 weight %. A suitable ethoxylated tristyrene phenol is α-[2,4,6-tris[1-(phenyl)ethyl]phenyl]-ω-hydroxy poly(oxyethylene). Suitably, the poly(oxyethylene) content averages from about 4 to about 150 moles. A commercially available example of this surfactant is Soprophor BSU®. In a particular embodiment, this surfactant is present at between about 5 and about 10 weight % and preferably at about 8.5 weight %.

In another embodiment, the anionic surfactant is a styrylphenol polyethoxyester phosphate. A suitable anionic surfactant is α-[2,4,6-tris[1-(phenyl)ethyl]phenyl]-ω-hydroxy poly(oxyethylene) ester phosphate. In particular, this compound is present as a mixture of the monohydrogen and dihydrogen phosphate esters and the corresponding ammonium, calcium, magnesium, potassium, sodium and zinc salts. Suitably, the poly(oxyethylene) content averages from about 4 to about 150 moles. A commercially available example of this surfactant is Soprophor 3D33®. In a particular embodiment, this surfactant is present at between about 5 and about 10 weight % and preferably at about 8.5 weight %.

In another embodiment, the solvent/carrier is tetrahydrofurfuryl alcohol. In a particular embodiment, the tetrahydrofurfuryl alcohol is present at between about 60 and 80 weight %, preferably at about 70 weight % and most preferably at 70.8 weight %.

As mentioned above, azoxystrobin is a strobilurin. It is noted that other strobilurins may also be used in the formulation of the present invention. Strobilurin and strobilurin-type fungicides are a well-known class of fungicides that act by inhibiting mitochondrial respiration by blocking electron transfer between cytochrome b and cytochrome c₁ at the ubiquinol oxidising site. They include the methoxyacrylate strobilurins such as azoxystrobin and picoxystrobin, the oximinoacetate strobilurins such as kresoxim-methyl and trifloxystrobin, the oximinoacetamide strobilurins such as dimoxystrobin, metominostrobin, orysastrobin (BAS 520) and the strobilurin of the formula: 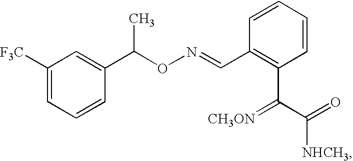
the dihydrodioxazine strobilurins such as fluoxastrobin, the methoxycarbamate strobilurins such as pyraclostrobin, the strobilurin of the formula: 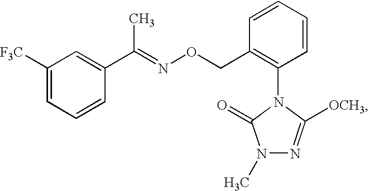
the imidazolinones strobilurin-types such as fenamidone, and the oxazolidinedione strobilurin-types such as famoxadone. Azoxystrobin is also described as entry 47 in The Pesticide Manual, Thirteenth Edition, published by The British Crop Protection Council, 2003. Picoxystrobin is also described in The Pesticide Manual as entry 647.

The present invention also provides for use of the formulation of the invention to control fungal disease in turfgrass and methods of controlling fungal disease by applying the formulation of the invention to turfgrass. In particular, the formulation of the present invention may be used for control of pathogens causing foliar and stem and root diseases of turfgrass plants. These diseases include, but are not limited to leaf and stem blights, leaf spots, patch diseases, mildews, anthracnose, fairy rings, molds and rusts. In particular, the formulation of the present invention may be used to control Colletotrichum graminicola (Anthracnose), Rhizoctonia solani (Brown Patch, Rhizoctonia Large Patch), Rhizoctonia cereralis (Cool Weather Brown Patch, Yellow Patch), Lycoperdon spp., Agrocybe pediades and Bovistra plumbea (all of which cause Fairy Rings), Microdocium nivale (Fusarium Patch, Pink Snow Mold), Pyricularia grisea (Gray Leaf Spot), Typhula incarnata (Gray Snow Mold, Typhula Blight), Puccinia spp. (Leaf Rust, Stem Rust, Stripe Rust), Bipolis sorokiniana (Leaf Spot), Drechslera poae (Melting Out), Leptosphaeria korrae (Necrotic Ring Spot), Limonomyses roseipellis (Pink Patch), Erysiphe graminis (Powdery Mildew), Pythium aphanidermatum and other Pythium species (Pythium Blight, Pythium Root Rot), Laetisaria fuciformis (Red Thread), Rhizoctania zeae (Rhizoctania Leaf Spot), Sclerotium rolfsii (Southern Blight), Leptosphaeria korrae, Gaeumannomyces graminis var. graminis or Ophiosphaerella herpotricha (all of which cause Spring Dead Spot), Magnaporthe poae (Summar Patch), Gaeumannomyces graminis var. avenae (Take-all Patch), Rhizoctonia solani and Gaeumannomyces incrustana (both of which may cause Zoysia Patch) and Sclerotinia homeocarpa (Dollar Spot).

In a particular embodiment, the fungal disease controlled by the formulation of the invention comprises Anthracnose, in particular, strobilurin tolerant Anthracnose and/or Dollar Spot.

In the context of the present invention, turfgrass includes, but is not limited to, turfgrass on golf courses, lawns and landscape areas around residential, institutional, public, commercial and industrial buildings, parks, recreational areas and athletic fields.

In addition, it is noted that the formulation of the present invention may also be used to control fungal disease on ornamental plants such as woody plants and perennials.

The formulation of the present invention may be applied using conventional techniques. In particular, the formulation of the invention may be applied as a foliar spray, perhaps in alternating spray programs, or in tank mixes with, for example, other turf protection products such as fungicides, fertilizers, herbicides, insecticides and biological control products. When applied as a foliar spray, the formulation of the present invention may conveniently be applied with all types of spray equipment commonly used for making ground applications. In addition, the formulation of the present invention may also be applied using a liquid fungicide injector to allow control of ectrotrophic root diseases (for example, Summer Patch and Take-all Patch).

Suitably, the formulation of the present invention is applied prior to disease development. Rates of use of the formulation are those conventionally used in the art. Suitably, 0.1 to 5.5 fluid ounces of the formulation are used per 1,000 square feet of turf grass to be treated, depending on the disease targeted. Most suitably, 1 to 2 fluid ounces of formulation per 1,000 square feet is used. The formulation of the invention may be applied in a single application or repeatedly at an interval of, suitably, between 10 and 28 days.

The formulations are prepared by any manner known in the art. Suitably, the solvent/carrier is added to a reactor vessel and heated and agitated while non-ionic and anionic surfactants are added. Finally, the active ingredient is added and the solution maintained at a specific temperature (suitably at less than 45° C.) and mixed until the active ingredient is completely dissolved.

The invention will now be described with reference to the following, non-limiting examples:

### EXAMPLES

### Example 1

Tetrahydrofurfuryl alcohol (I) was added to a reactor vessel with the capacity to heat and was agitated. The butanol PO/EO copolymer surfactant (II) was added first, followed by a tristyrylphenol polyethoxylate surfactant (III) and then the tristyrylphenol polyethoxyester phosphate surfactant (IV). Finally milled azoxystrobin technical (V) was added. The solution was heated and the temperature maintained at less than 45° C. while mixing until the azoxystrobin technical was completely dissolved.

The final proportions of components were as follows:
I: 70.8 weight %
II: 3.0 weight %
III: 8.5 weight %
IV: 8.5 weight %
V: 8.8 weight %

### Example 2

Studies were carried out to compare the present formulation with a widely available formulation of azoxystrobin currently on the market.

Perennial ryegrass (Lolium perenne) was track sprayed at 0.4 oz formulation/2 US gallons per 1,000 sq. ft. with the formulation made in Example 1 above and with a commercially available formulation of azoxystrobin. Foliar recoveries were analysed to assess uptake over seven days and the effect of rainwashing with 20 mm of rain per hour for one hour, 2 hours or 4 hours after spraying.

Results showed that the initial and final foliar uptake of azoxystrobin is faster from the formulation of the present invention. In addition, the residual formulation washed off the leaf surface more easily and virtually none of the new formulation remained on the leaf surface after rain. While not wishing to be bound, it is thought that this is due to a combination of the higher uptake and low surface tenacity of the formulation. By contrast, commercial formulations of azoxystrobin showed lower uptake and higher rainfastness.

In order to measure root uptake of the new formulation, the soil surface in which the perennial ryegrass was growing was treated using a Gilson multi-tip pipette; care was taken to avoid any direct contact between foliage and treatment suspension. The application was at 0.4 oz formulation/2 US gallons per 1,000 sq. ft. and grass leaves were analysed to assess uptake and translocation over seven days. Results showed that azoxystrobin from the present formulation is absorbed by the roots and translocated to the leaves more rapidly than azoxystrobin from commercially available formulations.

### Example 3

Studies were carried out to compare the efficacy of the present azoxystrobin formulation with a commercially available formulation. Results showed that the present formulation of azoxystrobin provided between 5 and 15% greater efficacy consistently and up to 50% better control for certain diseases such as strobilurin tolerant Anthracnose. In addition, the new formulation of azoxystrobin provided control of Dollar Spot, a disease not controlled by commercially available formulations.

1. A liquid formulation comprising:
a) a strobilurin fungicide
b) at least one non-ionic surfactant
c) at least one anionic surfactant
d) a solvent/carrier.

2. The formulation of claim 1 wherein the strobilurin fungicide is azoxystrobin.

3. The formulation of claim 1 wherein the at least one non-ionic surfactant comprises a copolymer of PO and EO or an ethoxylated tristyrene phenol.

4. The formulation of claim 3 wherein the copolymer is a butanol copolymer.

5. The formulation of claim 4 wherein the copolymer is α-butyl-ω-hydroxypoly (oxypropylene) block polymer with poly (oxyethylene).

6. The formulation of claim 3 wherein the ethoxylated tristyrene phenol is α-[2,4,6-tris[1-(phenyl)ethyl]phenyl]-ω-hydroxy poly(oxyethylene).

7. The formulation of claim 1 wherein the at least one anionic surfactant is a styrylphenol polyethoxyester phosphate.

8. The formulation of claim 7 wherein the anionic surfactant is a phosphate ester of α-[2,4,6-tris [1-(phenyl)ethyl]phenyl]-ω-hydroxy poly(oxyethylene).

9. The formulation of claim 1 wherein the solvent/carrier is tetrahydrofurfuryl alcohol.

10. The formulation of claim 1 which comprises
a) azoxystrobin,
b) α-butyl-ω-hydroxypoly (oxypropylene) block polymer with poly (oxyethylene),
c) α-[2,4,6-tris[1-(phenyl)ethyl]phenyl]- ω-hydroxy poly(oxyethylene),
d) a phosphate ester of α-[2,4,6-tris[1-(phenyl)ethyl]phenyl]-ω-hydroxy poly(oxyethylene) and
e) tetrahydrofurfuryl alcohol.

11. The formulation of claim 10 which comprises
a) 8.8 weight % azoxystrobin,
b) 3.0 weight % α-butyl-ω-hydroxypoly (oxypropylene) block polymer with poly (oxyethylene),
c) 8.5 weight % α-[2,4,6-tris[1-(phenyl)ethyl]phenyl]-ω-hydroxy poly(oxyethylene),
d) 8.5 weight % phosphate ester of α-[2,4,6-tris[1-(phenyl)ethyl]phenyl]-ω-hydroxy poly(oxyethylene) and
e) 70.8 weight % tetrahydrofurfuryl alcohol.

12. A method of preventing and/or treating fungal infection of plants comprising applying an effective amount of the formulation of claim 1 to the plant.

13. The method of claim 12 wherein the plant is a turf plant.

14. The method of claim 12 wherein the fungal infection is Anthracnose or Dollar Spot.
